(19) United States
(12) Patent Application Publication
(10) Pub. No.: US 2011/0290974 A1
(43) Pub. Date: Dec. 1, 2011

(54) RETAINING STRUCTURE HAVING LOCKING APPARATUS

(75) Inventor: Chao-hsiung WU, Wugu City (TW)

(73) Assignee: HANNSTAR DISPLAY CORPORATION, Wugu (TW)

(21) Appl. No.: 12/899,546

(22) Filed: Oct. 7, 2010

(30) Foreign Application Priority Data
May 26, 2010 (TW) 099116823

(51) Int. Cl. F16M 13/00

(52) U.S. Cl. 248/346.03

(57) ABSTRACT

A retaining structure is described. The retaining structure includes a supporting part and a plurality of locking apparatuses. The supporting part has a plurality of position portions and each of the position portions has an annular portion. The locking apparatuses are deposed between the in the component and the supporting part and are corresponding to the position portions of the supporting part. Each of the locking apparatuses includes a main body and a fastening portion. The main body has a first portion, a second portion, and an annular region. The first portion is joined to the annular portion of the position portion and the second portion is joined to the opening of the component. The fastening portion is joined to the annular region of the main body to allow the fastening portion to contact the annular region for fastening the component on the supporting part.

### FIELD OF THE INVENTION

The present invention relates to a retaining structure, and more particularly to a retaining structure having a locking apparatus.

### BACKGROUND OF THE INVENTION

FIG. 1A is a schematic view of a first retaining structure for speaker 104 in the prior art. The retaining structure for speaker 104 utilizes the screw 102 for locking the speaker 104 on the supporting post 106. The rubber washer 107 is attached to the screw 102 and the speaker 104. Although the retaining structure for speaker 104 can eliminate a portion of the resonance vibration of the speaker 104, it takes a long time to screw and install the screw 102 to the supporting post 106, resulting in inefficient manufacturing. Further, if the exerted force on the screw 102 is not uniform, the speaker 104 and the supporting post 106 crack when the screw 102 is tightly screwed into the supporting post 106. In another case, the hot melt adhesive (not shown) is used to replace the screw 102 to prevent the uneven exertion force. However, the hot melt adhesive tends to melt the speaker 104 and the supporting post 106 and/or deforms the speaker composed of the plastic material and the supporting post 106.

FIG. 1B is a schematic view of a second retaining structure for speaker 104 in the prior art. The retaining structure for speaker 104 utilizes the upper plate 110a and the lower plate 110b for clasping the speaker 104 wherein the upper rip 112a of the upper plate 110a and the lower rip 112b of the lower plate 110b hold the four corners of the speaker 104. After the speaker 104 is put to the lower rip 112b of the lower plate 110b and when the user desires to insert the upper rip 112a of the upper plate 110a to the upper corners, the speaker 104 cracks and damages since the user cannot see the two sides of the upper corners of the speaker 104 and the upper rip 112a of the upper plate 110a does not align to the lower rip 112b of the lower plate 110b. Further, it is difficult to control the spacing tolerance between the upper rip 112a and the lower rip 112b, which increases the manufacturing cost of the upper rip 112a and the lower rip 112b.

FIG. 1C is a schematic view of a third retaining structure for speaker in the prior art. The retaining structure for speaker 104 utilizes the upper plate 110a and the lower plate 110b for locating the speaker 104 wherein a piece of rubber 114 is stuffed between the upper plate 110a and the speaker 104 and the speaker 104 is held by the pin 116 of the lower plate 110b in form of loose fit. When the resonance vibration appears on the speaker 104, the rubber 114 falls off and the speaker 104 cannot be stably held.

Consequently, there is a need to develop a novel retaining structure to solve the aforementioned problems of the speaker 104.

### SUMMARY OF THE INVENTION

The first objective of the present invention is to provide a retaining structure having a locking apparatus for fastening a component to the position portion of the supporting part in order to precisely control the spacing tolerance between the position portion and the component. Further, the retaining structure having the locking apparatus stably inserts the component into the supporting part to solve the problems of loosing, vibration and damage of the component. The component is a speaker, a device having the feature of vibration, and/or a device which can be fastened.

The second objective of the present invention is to provide a retaining structure having a locking apparatus for fastening the component to the position portion in order rapidly assemble the component to increase the manufacturing efficiency and save the cost.

According to the above objectives, the present invention sets forth the retaining structure having a locking apparatus. The retaining structure has a locking apparatus for fastening a component having a plurality of openings. The retaining structure includes a supporting part and a plurality of locking apparatuses. The supporting part has a plurality of position portions wherein each of the position portions has an annular portion. The locking apparatuses are disposed between the component and the supporting part and the locking apparatuses are corresponding to the position portions of the supporting part respectively. Each of the locking apparatuses includes a main body and a fastening portion. The main body has a first portion, a second portion and an annular region. The first portion is joined to the annular portion for positioning the main body on the supporting part, and the second portion is joined to one of the openings of the component for positioning the component on the main body. The fastening portion is connected to the main body wherein the fastening portion is joined to the annular region of the main body to allow the fastening portion to contact the annular region so that the first portion of the main body holds the annular portion of the position portion for fastening the component on the supporting part.

The present invention sets forth a locking apparatus. The locking apparatus fastens a component having a plurality of openings to a supporting part. The supporting part has a plurality of position portions. Each of the position portions has an annular portion, a plurality of locking apparatuses are disposed between the component and the supporting part. The locking apparatuses are corresponding to the position portions of the supporting part respectively. Each of the locking apparatuses includes a main body and a fastening portion. The main body has a first portion, a second portion and an annular region, wherein the first portion is joined to the annular portion for positioning the main body on the supporting part, and the second portion is joined to one of the openings of the component for positioning the component on the main body. The fastening portion is connected to the main body wherein the fastening portion is joined to the annular region of the main body to allow the fastening portion to contact the annular region so that the first portion of the main body holds the annular portion of the position portion for fastening the component on the supporting part.

The retaining structure having the locking apparatus stably inserts the component into the supporting part to solve the problems of loosing, vibration and damage of the component.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic view of a first retaining structure for speaker in the prior art;

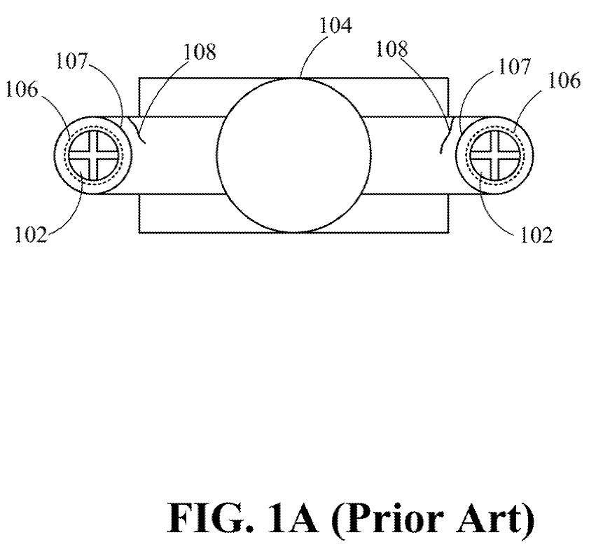

FIG. 1B is a schematic view of a second retaining structure for speaker in the prior art;

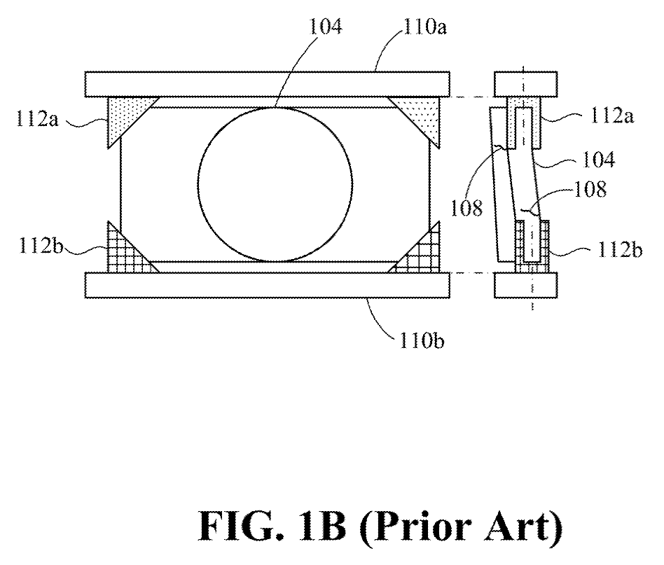

FIG. 1C is a schematic view of a third retaining structure for speaker in the prior art;

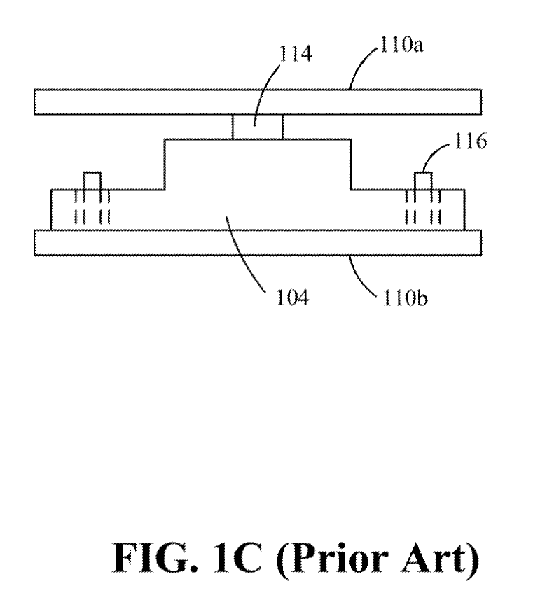

FIG. 2 is a schematic three-dimensional exploded view of the retaining structure according to one embodiment of the present invention;

FIG. 3 is a schematic three-dimensional view of the retaining structure according to one embodiment of the present invention;

FIG. 4 is a schematic cross-sectional view of the locking apparatus of the retaining structure according to one embodiment of the present invention; and

FIG. 5 is a schematic cross-sectional view of the retaining structure according to one embodiment of the present invention.

### DETAILED DESCRIPTION OF THE PREFERRED EMBODIMENTS

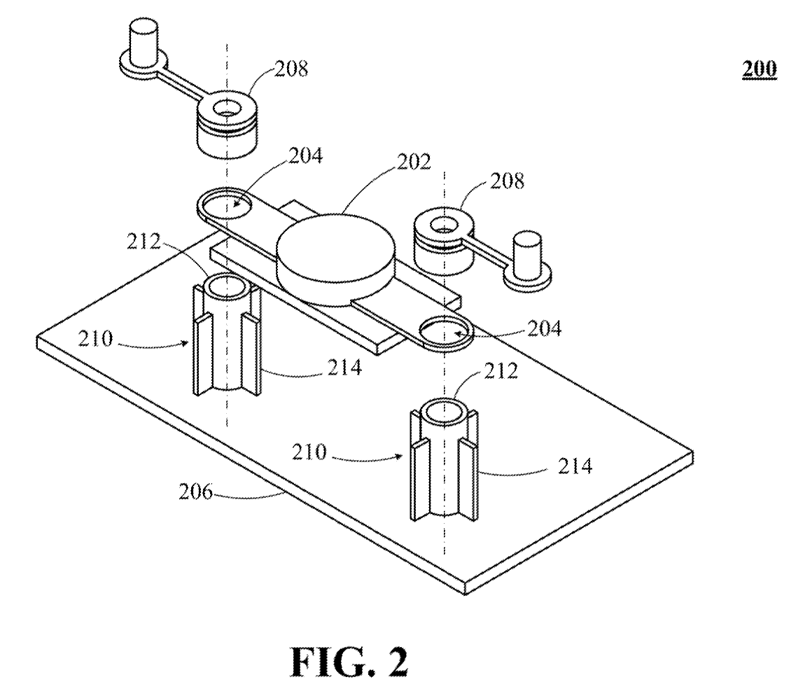

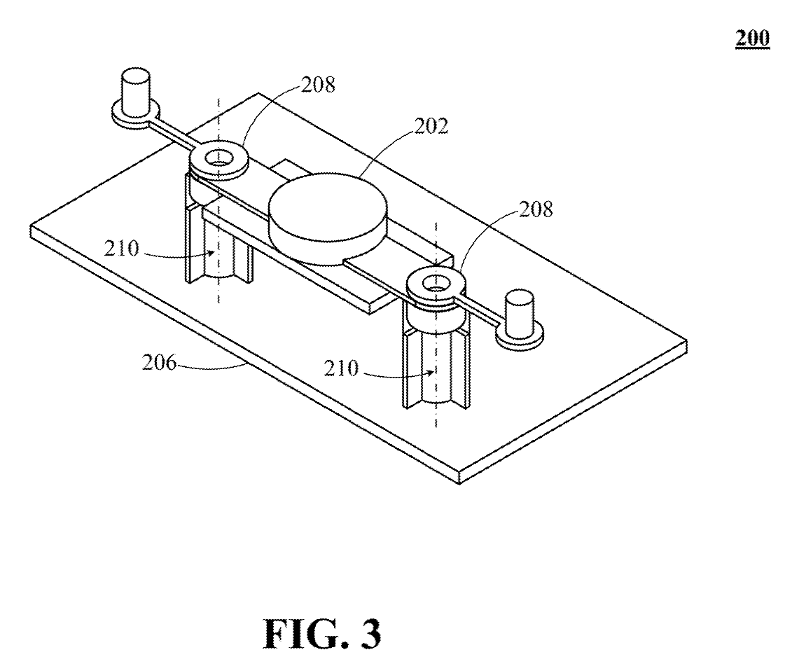

Please refer to FIG. 2 and FIG. 3. FIG. 2 is a schematic three-dimensional exploded view of the retaining structure 200 according to one embodiment of the present invention. FIG. 3 is a schematic three-dimensional view of the retaining structure 200 according to one embodiment of the present invention. The retaining structure 200 fastens a component 202 having a plurality of openings 204. The retaining structure 200 includes a supporting part 206 and a plurality of locking apparatuses 208. The supporting part 206 has a plurality of position portions 210 wherein each of the position portions 210 has an annular portion 212. For example, the position portions 210 are position posts and/or protrusion parts on the supporting part 206 and the annular portion 212 is a hollow region formed by the position portions 210. The locking apparatuses 208 are disposed between the component 202 and the supporting part 206 and the locking apparatuses 208 are corresponding to the position portions 210 of the supporting part 206 respectively. In this case, the retaining structure 200 includes two locking apparatuses 208 which are corresponding to two position portions 210 for locking the left and right sides of the component 202. It should be noted that at least one of the locking apparatus 208 is used to lock the component 202. In one embodiment, the component 202 is a speaker or the device having the feature of vibration. The supporting part 206 is a supporting plate and each of the position portions 210 is a position post.

When the locking apparatus 208 is employed to fasten the component 202 to the supporting part 206, the locking apparatus 208 holds on the opening 204 of the component 202 and the locking apparatus 208 is disposed in the position portion 210 for fastening the component 202 to the supporting part 206. In one preferred embodiment, after the locking apparatus 208 is inserted to the component 202, the component 202 with the locking apparatus 208 is the put into the annular portion 212 of the position portion 210. In another embodiment, after the locking apparatus 208 is put into the annular portion 212 of the position portion 210, the locking apparatus 208 is the inserted to the component 202. The above-mentioned method utilizes the locking apparatus 208 of the retaining structure 200 for stably assembling the component 202 on the supporting part 206 to precisely control the spacing tolerance between the position portion 210 and the component 202 and solve the problems of loosing, vibration and damage of the component 202. The locking apparatus 208 of the retaining structure 200 is described in detail as follows.

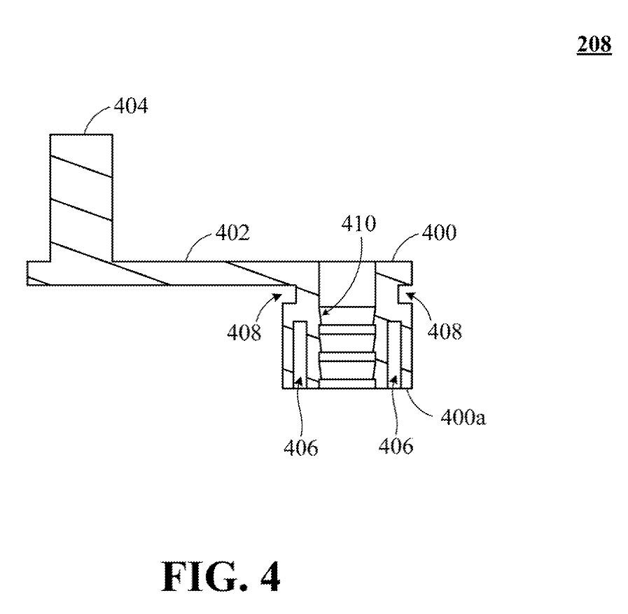

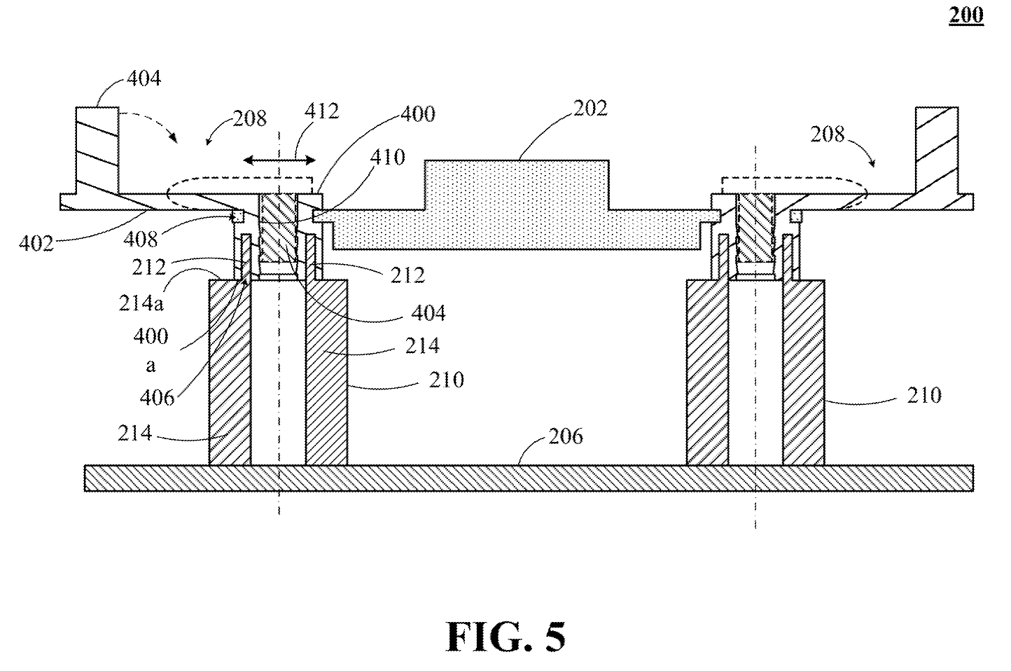

Please refer to FIG. 4 and FIG. 5. FIG. 4 is a schematic cross-sectional view of the locking apparatus 208 of the retaining structure 200 according to one embodiment of the present invention. FIG. 5 is a schematic cross-sectional view of the retaining structure 200 according to one embodiment of the present invention. The locking apparatus 208 has a main body 400, a connection part 402 and a fastening portion 404. The main body 400 has a first portion 406, a second portion 408 and an annular region 410. The first portion 406 is joined to the annular portion 212 for positioning the main body 400 on the supporting part 206, and the second portion 408 is joined to one of the openings 204 of the component 202 for positioning the component 202 on the main body 400. In one embodiment, the first portion 406 and the second portion 408 of the main body 400 are an annular recess, respectively.

The fastening portion 404 is connected to the main body 400 by the connection part 402 wherein the fastening portion 404 is joined to the annular region 410 of the main body 400 to allow the fastening portion 404 to contact (e.g. squeezing) the annular region 410 so that the first portion 406 of the main body 400 holds the annular portion 212 of the position portion 210 for fastening the component 202 on the supporting part 206 in order to hold the component 202 on the supporting part 206. In one case, the main body 400 and the fastening portion 404 are an integrated structure. In another case, the main body 400 and the fastening portion 400 are two parts respectively by omitting the connection part 402. For example, either the fastening portion 404 of each of the locking apparatuses 208 is a post shape or the fastening portion 404 has the plug shape to be easily inserted to the annular region 410 of the main body 400.

In FIG. 4 and FIG. 5, as shown by the connection part 402 and the fastening portion 404 in dashed line, the locking apparatus 208 fastens the component 202 to the supporting part 206 when the fastening portion 404 is joined to the annular region 410 of the main body 400, i.e. the fastening portion 404 is inserted to the annular region 410 of the main body 400 by bending the connection part 402. That is, the fastened region of the locking apparatus 208 includes that the main body 400 clasps the position portion 210 and the buckles the component 202.

Specifically, when the main body 400 of the locking apparatus 208 is fastened to the position portion 210, the fastening portion 404 outwardly squeezes the annular region 410 along the radius direction 412 of the annular portion 212 so that the first portion 406 of the main body 400 contacts (tight fit or interference fit) the position portion 210, and the first portion 406 thus clasps the annular portion 212 of the position portion 210 for stably fastening the supporting part 206 to the position portion 210 by the locking apparatus 208. In one preferred embodiment, the material of the locking apparatus 208 is buffering material such as the rubber of plastic of non-metal material for providing the elastic contact between the main body 400 and the position portion 210 for avoiding the damage of the supporting part 206.

When the main body 400 of the locking apparatus 208 fastens the component 202, the fastening portion 404 outwardly squeezes the annular region 410 along the radius direction 412 of the opening 204 so that the second portion 408 of the main body 400 contacts (tight fit or interference fit) the opening 204 by joining the second portion 408 to the opening 204 of the component 202. In other words, since the second portion 408 of the main body 400 tightly contacts (i.e. tight fit or interference fit) the opening 204, the main body 400 of the locking apparatus 208 is capable of holding the component 202 to prevent the loosing status and to reduce the resonance phenomenon of the component 202. In one preferred embodiment, the material of the locking apparatus 208 is buffering material such as the rubber of plastic of non-metal material for providing the elastic contact between the main body 400 and the opening 204 for avoiding the damage and resonance vibration of the component 202.

In one case, the annular region 410 of the main body 400 is an annular sidewall having a rough surface to generate the friction force between the fastening portion 404 and the annular region 410 for increasing the stability of the main body 400, the position portion 210 and the opening 204 therebetween. In one preferred embodiment, the rough surface of the annular sidewall is a sawtooth shape. When the sawtooth shape is downward formed, the fastening portion 404 is capable of being inserted into the annular region 410 so that the fastening portion 404 is not easily to be detached from the annular region 410. In the present invention, the retaining structure 200 utilizes the fastening portion 404 to be inserted into the annular region 410 for rapidly assembling the component 202 to increase the manufacturing efficiency and save the cost.

In one embodiment, a plurality of enhanced portions 214 disposed around the position post 210 and each of the enhanced portions 214 is a supporting rib. For example, four supporting ribs are disposed around the position post 210, but not limited. The top portion 214a of each of the enhanced portions 214 supports the bottom portion 400a of the main body 400. That is, the top portion 214a withstands the bottom portion 400a for increasing stability between the locking apparatus 208 and the position portion 210.

According to the above-mentioned descriptions, the present invention provides a retaining structure having a locking apparatus for fastening a component to the position portion of the supporting part in order to precisely control the spacing tolerance between the position portion and the component. Further, the retaining structure having the locking apparatus stably inserts the component into the supporting part to solve the problems of loosing, vibration and damage of the component. Moreover, the locking apparatus fastens the component to the position portion for rapidly assembling the component to increase the manufacturing efficiency and save the cost.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A retaining structure having a locking apparatus for fastening a component having a plurality of openings, the retaining structure comprising:
a supporting part having a plurality of position portions wherein each of the position portions has an annular portion; and
a plurality of locking apparatuses disposed between the component and the supporting part and corresponding to the position portions of the supporting part respectively, wherein each of the locking apparatuses comprises:
a main body having a first portion, a second portion and an annular region, wherein the first portion is joined to the annular portion for positioning the main body on the supporting part, and the second portion is joined to one of the openings of the component for positioning the component on the main body; and
a fastening portion connected to the main body, wherein the fastening portion is joined to the annular region of the main body to allow the fastening portion to contact the annular region so that the first portion of the main body holds the annular portion of the position portion for fastening the component on the supporting part.

2. The retaining structure of claim 1, wherein the annular region of the main body is an annular sidewall having a rough surface with a sawtooth shape.

3. The retaining structure of claim 1, wherein the material of the locking apparatus is non-metal material.

4. The retaining structure of claim 1, wherein the first portion and the second portion of the main body are an annular recess, respectively.

5. The retaining structure of claim 1, wherein the fastening portion of each of the locking apparatuses is a post shape.

6. The retaining structure of claim 1, wherein the first portion of the main body contacts one of the position portions and the second portion of the main body contacts one of the openings of the component.

7. The retaining structure of claim 1, wherein either the main body and the fastening portion are an integrated structure or the main body is coupled to the fastening portion by a connection part.

8. The retaining structure of claim 1, wherein the supporting part is a supporting plate and each of the position portions is a position post, and wherein a plurality of enhanced portions are disposed around the position post, an top portion of each of the enhanced portions supports the bottom portion of the main body, and each of the enhanced portions is a supporting rib.

9. A locking apparatus for fastening a component having a plurality of openings to a supporting part, wherein the supporting part has a plurality of position portions, each of the position portions has an annular portion, a plurality of locking apparatuses are disposed between the component and the supporting part, and the locking apparatuses are corresponding to the position portions of the supporting part respectively, each of the locking apparatuses comprising:
a main body having a first portion, a second portion and an annular region, wherein the first portion is joined to the annular portion for positioning the main body on the supporting part, and the second portion is joined to one of the openings of the component for positioning the component on the main body; and
a fastening portion connected to the main body, wherein the fastening portion is joined to the annular region of the main body to allow the fastening portion to contact the annular region so that the first portion of the main body holds the annular portion of the position portion for fastening the component on the supporting part.

10. The locking apparatus of claim 9, wherein the annular region of the main body is an annular sidewall having a rough surface with a sawtooth shape.

11. The locking apparatus of claim 9, wherein the material of the locking apparatus is non-metal material.

12. The locking apparatus of claim 9, wherein the first portion and the second portion of the main body are an annular recess, respectively.

13. The locking apparatus of claim 9, wherein the fastening portion of each of the locking apparatuses is a post shape.

14. The locking apparatus of claim 9, wherein the first portion of the main body contacts one of the position portions and the second portion of the main body contacts one of the openings of the component.

15. The locking apparatus of claim 9, wherein either the main body and the fastening portion are an integrated structure or the main body is coupled to the fastening portion by a connection part.
